(19) United States
(12) Patent Application Publication
(10) Pub. No.: US 2017/0130526 A1
(43) Pub. Date: May 11, 2017

(54) DOUBLE ROLL-TYPE CLOSURE

(71) Applicant: GAPOSA S.R.L., Fermo (FM) (IT)

(72) Inventors: Paolo GASPARRINI, Fermo (FM) (IT); Alessandro MAZZONI, Fermo (FM) (IT)

(73) Assignee: GAPOSA S.R.L., Fermo (FM) (IT)

(21) Appl. No.: 15/318,249

(22) PCT Filed: Jun. 16, 2015
(86) PCT No.: PCT/EP2015/063405

§ 371 Date: Dec. 12, 2016

(30) Foreign Application Priority Data
Jun. 19, 2014 (IT) MC2014A000053

(51) Int. Cl. E06B 9/44; E06B 9/42; E06B 9/72

(52) U.S. Cl. CPC E06B 9/44; E06B 9/72; E06B 9/42; E06B 2009/405

(57) ABSTRACT

A roll type closure has a fixed mounting frame, an inner curtain secured to an inner roller, an outer curtain secured to an external roller rotatably mounted to the inner roller, actuating mechanisms, a bottom rail disposed at the free end of the inner curtain and coupled with the outer roller so as to make the inner and outer rollers integral in rotation, a lever with a hook mounted on the outer roller to move from a retracted position, where the hook does not protrude from the outer roller, to an extracted position, where the hook protrudes from the outer roller, the lever being in the extracted position when the outer curtain is unrolled completely, and a stop member mounted in the frame such that when the lever is in the extracted position the hook is stopped against the stop member, blocking the rotation of the outer roller.

The present invention relates to a double roll type closure, such as for example roller shades, Roman shades, solar protection screens, black-out blinds, mosquito nets, home video screens and the like.

Roll type closures comprising roller shades or black-out blinds or screens are known in the prior art as solar protection means in houses or commercial buildings with an increasingly important energy-saving function. The said closures also have additional purposes in interior decoration: for example, daylight modulation, darkening, acoustic dampening, and privacy.

Typically such roll type closures comprise a roller or roller tube supported at the ends by supports, around which a flexible panel (normally made of fabric or laminate or extruded) is rolled and unrolled according to the light intensity required in the building. The roll type closure can be generally operated manually by means of a suitable chain or crank handle, but it is often provided with an electric motor for higher convenience. An option of the electrical operation is also the possibility to use a manual actuation in case of a defect or a power outage.

The curtain, chosen as decorative curtain, must have a given transparency according to the exposure of the window to be decorated and the requested filtering effect.

Of course, the wider the light modulation is, from maximum transparency to total blackout, the higher the benefits for the end user of this type of closure will be.

A common single roller shade assembly provides for a limited daylight modulation function compared to the maximum controllable range and is a good compromise between decoration and privacy.

In order to control all light intensity levels in an indoor space at best, a second roll type closure made of a completely black-out fabric is commonly installed in front of or behind the filtering curtain. Typically such a second curtain is located offset with respect to the first curtain to reduce the volume of the double installation.

In an alternative configuration, the first curtain acts as a mosquito net and the second curtain has a filtering or darkening function.

This type of double roll closure is known as “dual shade assembly”.

The dual shade assembly is a common and very useful solution for solar protection in interiors.

However, one drawback of such an assembly is the limited compactness: although offset, two curtains take a considerable space in the limited surfaces that are normally reserved to solar protection.

Another drawback of the traditional dual shade assembly is represented by the high (practically double) costs compared to a single shade assembly. Such a drawback is made worse especially in case of motorized shades.

U.S. Pat. No. 5,647,421 discloses a dual shade assembly comprising an inner shade panel connected to an inner roller and an outer shade panel connected to an outer roller. The inner and outer rollers are coaxial and the outer roller is rotatably supported by the inner roller. The free ends of the inner and outer shade panels are provided with bottom rails that act as counterweight to prevent the outer roll from rotating during the unrolling of the inner shade.

However, such a counterweight balancing turns out to be complex, uncertain and unstable and the outer roller often continues on rotating during the unrolling of the inner shade, preventing the correct unrolling of the inner shade.

EP1895070 discloses an awning assembly adapted to be mounted in a structure and comprising a primary roller having an internal cavity, and a secondary roller rotatably mounted within the internal cavity of the primary roller.

U.S. Pat. No. 6,876,493 discloses an electric projection screen roller and bottom rail assembly.

It is an object of the present invention to eliminate the drawbacks of the prior art by providing a double roll type closure that allows for a wide daylight modulation control and provides an attractive interior decoration.

It is a further object of the present invention to provide such a double roll type closure that is compact, not cumbersome and reliable.

It is an additional object of the present invention to provide such a double roll type closure that is inexpensive, especially when motorized.

These objects are achieved according to the invention with the characteristics of the independent claim 1.

Advantageous embodiments of the invention become apparent from the dependent claims.

The present invention relates to a double roll type closure, such as roller shades, black-out blinds or generally solar protection shades, etc., comprising a first roller or a curtain roller tube, coaxially inserted inside a second roller or roller tube, which is larger than the first one, around which a second curtain is rolled. Both inner and outer roller tubes rotate on the same axis of rotation.

The inner roller is supported at the two ends by mounting brackets secured to the wall. The inner roller has an end-cap mounted at one end, whereas the other end of the inner tube is provided with an actuating mechanism that in the preferred embodiment is a a tubular geared motor or, in simpler and cheaper embodiments, is a chain or crank handle.

The outer roller is supported by bearings or low friction bushings placed on the end-cap of the inner roller or, in an alternative embodiment, on the mounting brackets secured to the wall.

The outer roller has a generally round profile provided with a slot on the entire length for the passage of the curtain rolled on the inner tube. The inner curtain can be unrolled only when the outer curtain, which rolls and unrolls on the outer roller, is completely unrolled.

The inner curtain has a bottom rail provided with a profile adapted to be attached and received in a recess of the outer roller profile when the inner curtain is completely rolled. Continuing in the same rolling direction the inner curtain will drive into rotation the outer tube through the bottom rail so that the two tubes will rotate together, consequently rolling or unrolling the outer curtain.

In the rolling direction of the two curtains—inner and outer—the sequence is the following:

from a situation with both curtains open (the outer curtain completely unrolled so that the slot on the tube allows the inner curtain to be unrolled), the actuating mechanism, either manual or electric, will actuate on the inner tube to which it is connected and will first roll the inner curtain completely and only when the inner curtain is completely rolled, the bottom rail engaged on the outer roller will drive into rotation the outer curtain until it is completely closed.

In the unrolling direction of the two curtains the sequence is reversed: first the outer curtain unrolls and when the outer curtain is unrolled completely, then the inner curtain will go into rotation until it is completely open.

In order to work properly, the aforementioned assembly requires a mechanism which acts to coordinate the movement between the outer roller and the inner roller in the unrolling direction of the curtains. Such coordination occurs through the constrained stop of the outer roller at a given position when the maximum opening (free slot) is reached in order to allow the inner curtain to unroll freely.

The mechanism comprises a lever with a hook and a retaining spring that is fixed on the edge of the outer roller and a stop member housed in the curtain mounting bracket.

Through a pivot the lever remains in an idle position due to the pressure of the outer fabric when rolled on the roller. In such a condition the outer roller can rotate freely in opening or closing without constraints. When the curtain is unrolled completely, uncovering the surface of the outer roller, the lever loses the pressure of the fabric and is raised. Consequently, by means of the reaction spring, the lever directs the hook in such manner that the hook is engaged in the stop member. The effect generated by the mechanism at a precise opening angle of the hook is to lock the rotation of the outer roller and consequently activate the unrolling of the inner curtain. The outer roller will keep the angular position so that the slot through which the outer curtain passes is in the expected most favorable position.

During the rolling of the two curtains, when the inner curtain drives into rotation the outer roller by means of the bottom rail, when rolling, the outer curtain will cover the lever, pressing it and therefore releasing and bringing the hook back to the idle position until the outer curtain is not unrolled completely again.

This coordination mechanism allows the double roll type closure according to the present invention to offer a very wide daylight modulation with a compact installation.

Further features of the invention will become apparent from the following detailed description, which refers to a merely illustrative, not limiting embodiment, illustrated in the enclosed figures, wherein:

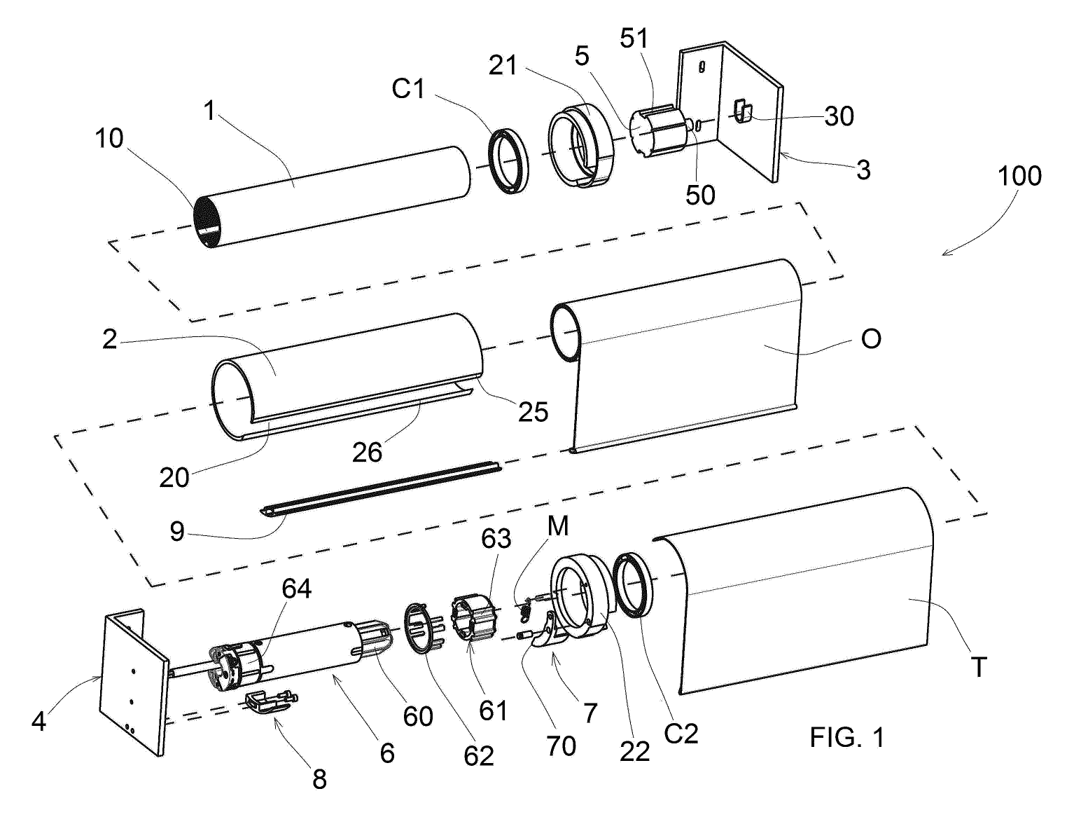

FIG. 1 is an exploded perspective view of the different elements of the roll type closure in accordance with the invention;

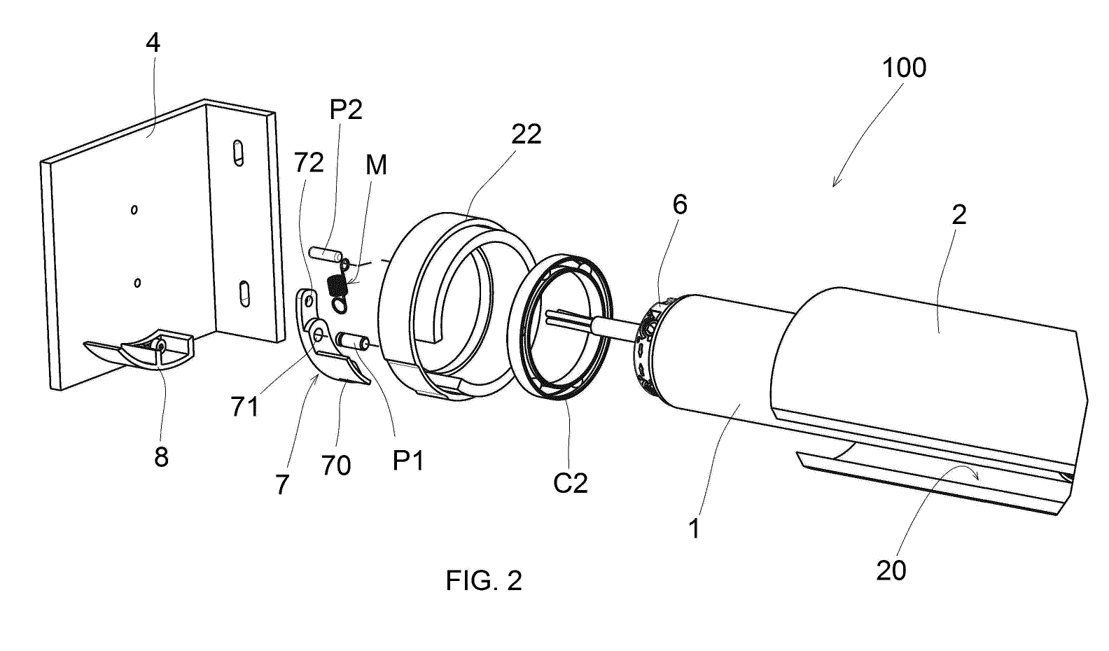

FIG. 2 is a perspective view from a different direction compared to FIG. 1, showing some partially interrupted, assembled elements and other elements in an exploded view;

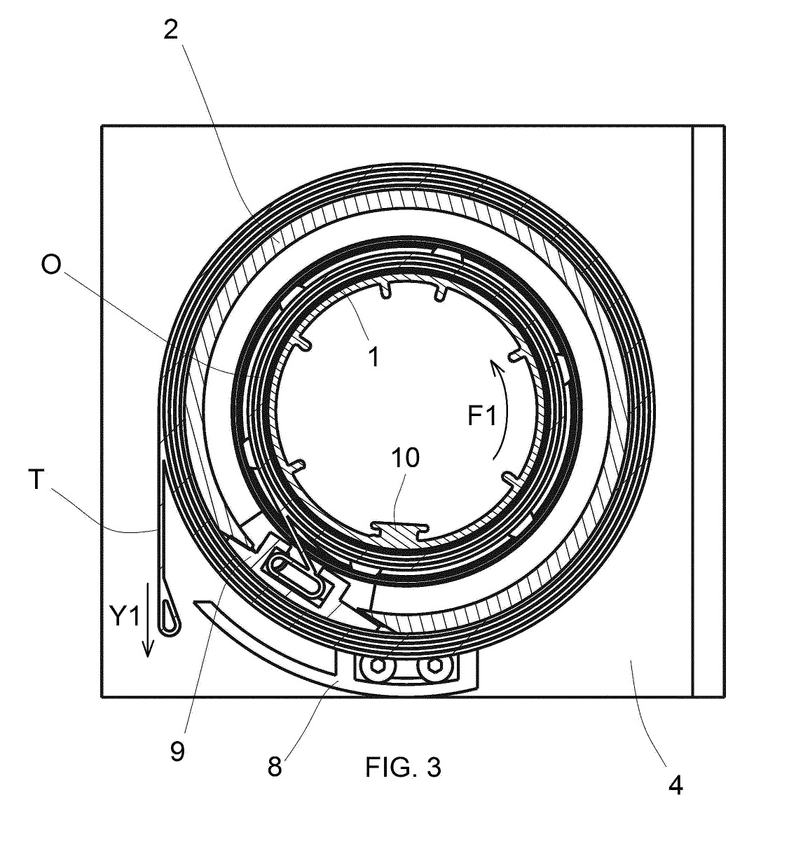

FIG. 3 is a cross-sectional view of the roll type closure of FIG. 1, here assembled, in a situation in which the inner curtain and the outer curtain are rolled completely;

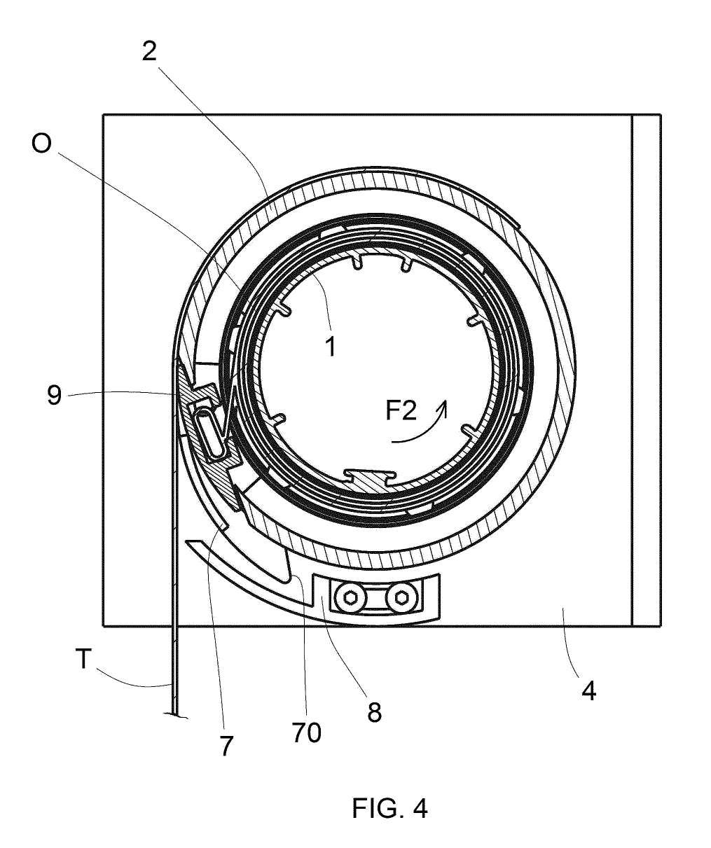

FIG. 4 is the same view as FIG. 3, in which the outer curtain is unrolled completely and the inner curtain is rolled completely;

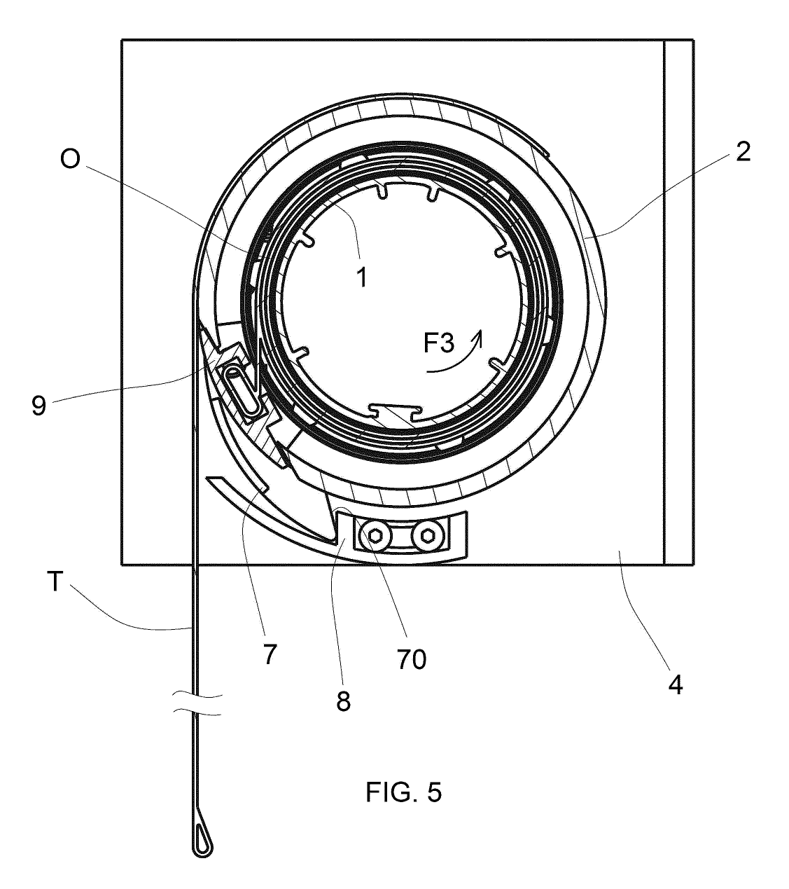

FIG. 5 is the same view as FIG. 4 in which the inner curtain starts being unrolled, and

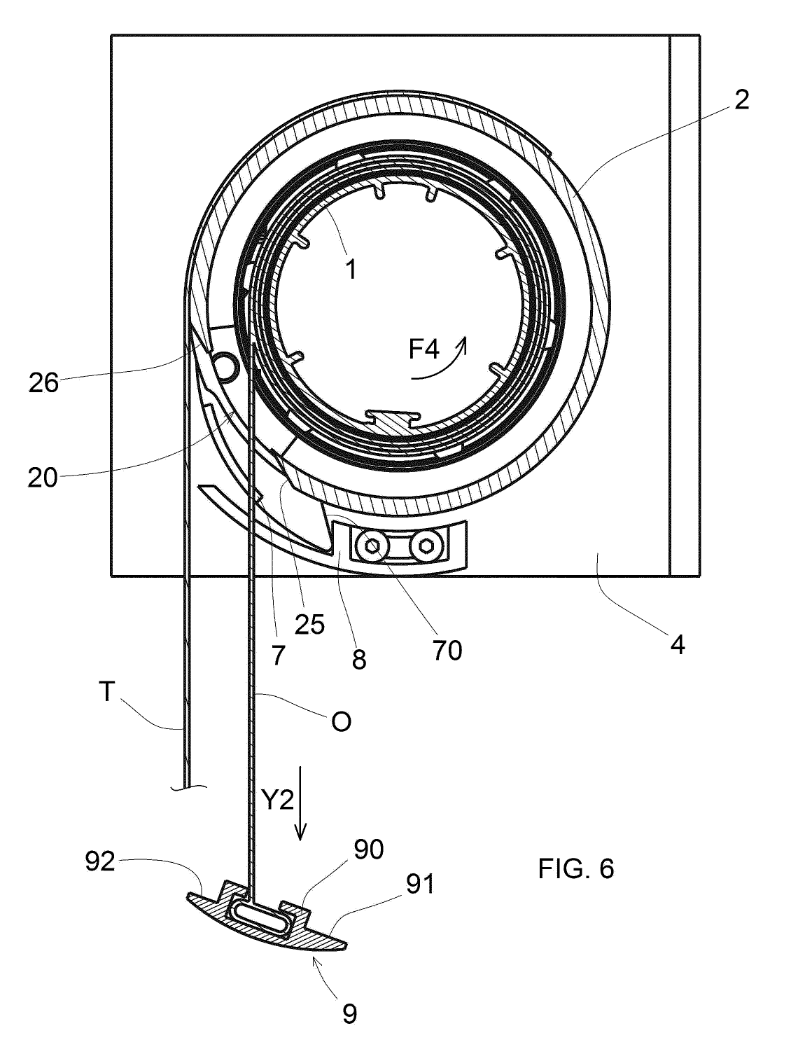

FIG. 6 is the same view as FIG. 5, in which the inner curtain is partially unrolled.

Referring to the figures the roll type closure in accordance with the invention is disclosed, being generally indicated with reference numeral (100).

The roll type closure assembly (100) comprises an inner roller (1) and an outer roller (2). An inner curtain (O) is attached to the inner roller (1) in order to be rolled and unrolled on the inner roller (1). An outer curtain (T) is attached to the outer roller (2) in order to be rolled on the outer roller (2).

The outer curtain (T) is normally intended to face the interior of the building and is generally a translucent curtain, which from now on will be called curtain (T). The inner curtain (O) is intended to face the exterior of the building and is generally a black-out blind, which from now on will be called black-out blind (O).

The inner roller (1) is coaxially inserted into the outer roller (2). For this purpose, the outer roller is a hollow cylindrical tube with a longitudinal slot (20) where the black-out blind (O) passes through.

The roll type closure assembly (100) comprises a fixed mounting frame comprising a first flange (3) and a second flange (4) intended to be secured to the wall in order to support the different elements of the assembly (100). Each flange (3,4) is shaped like an “L” plate.

The first flange (3) comprises a “U” seat (30) which rotatably supports a pin (50) of an end-cap (5), of substantially cylindrical shape, placed inside the inner roller (1). For this purpose, the end-cap (5) is shaped as a sleeve provided with at least one outer groove (51) and the inner roller (1) is a hollow cylindrical tube provided with at least one rib (10) inwardly protruding, which is intended to be coupled in the groove (51) of the end-cap.

A first collar (21) and a second collar (22) are secured respectively to a first end and a second end of the outer roller (2). A first bearing (C1) is disposed between the inner roller (1) and the first collar (21). A second bearing (C2) is disposed between the inner roller (1) and the second collar (22). In this manner, the outer roller (2) is rotatably supported on the inner roller (1) and the two rollers (1,2) can rotate freely.

An electric motor (6) is secured to the second flange (4) and is connected to the inner roller (1) to drive it into rotation. The electric motor (6) comprises a drive shaft (60), a stop ring (64), and a pair of adaptors (61, 62).

The pair of adaptors (61, 62) comprises a first adaptor (61) and a second adaptor (62). The first adaptor (61) is a power take-off mounted on the drive shaft (60) and the second adaptor (62) is a driving wheel mounted on the stop ring (64). The pair of adaptors (61, 62) has a shape substantially similar to the end cap (5). For that purpose the first and second adaptor (61, 62) are adapted to be inserted into the inner roller (1) and both adaptors (61, 62) comprise at least one groove (63) adapted to accommodate the rib (10) of the inner roller (1).

The rotating part of the motor (6) is keyed on the inner roller (1) to drive it into rotation. In this manner, the rotation of the drive shaft (60) drives in rotation the first adaptor (61) which in turn drives in rotation the inner roller (1), driving the stop ring (64) through the driving wheel (61) in order to control the revolutions of the drive shaft (60).

A lever (7) comprises a hook (70). The lever (7) is connected to the outer roller (2) in such manner that the hook (70) protrudes outwards with respect to the outer roller (2). In particular, the lever (7) is connected with the second collar (22) secured at one end of the outer roller (2).

With reference to FIG. 2, the lever (7) has a curved shape and is pivoted to the second collar (22) by means of a pin (P1) in such manner to act as a lever. In this manner, the lever (7) can rotate around the axis of the pin

(P1) moving from a retracted position, in which the hook (70) does not protrude from the outer roller tube (2), to an extracted position, in which the hook (70) protrudes from the outer roller (2).

A peg (P2) is secured to the second collar (22) and a spring (M) is placed between the peg (P2) and the lever (7) in such manner to keep the lever (7) in its extracted position. In FIG. 4 the hook (70) of the lever is shown in extracted position. For this purpose the lever (7) comprises a first hole (71) for accommodating the pin (P1) and a second hole (72) for accommodating one end of the spring (M).

A stop member (8) is secured to the second flange (4) so that, when in extracted position, the hook (70) of the lever (7) can abut against the stop member (8). The stop member (8) has a curved shape that is substantially similar to that of the hook (70) of the lever. FIGS. 5 and 6 show the hook (70) against the stop member (8).

With reference to FIGS. 1 and 6, a bottom rail (9) is secured to the free end of the black-out blind (O). With reference to FIG. 3, when the black-out blind (O) is rolled completely in the inner roller (1), the bottom rail is engaged in the longitudinal slot (20) of the outer roller (2), thus making the inner (2) and the outer rollers (1) integral while rotate.

For this purpose the longitudinal slot (20) of the outer roller is arranged between two longitudinal edges (25, 26) with surfaces lying on a plane. The bottom rail (9) has a substantially “T” cross-section and comprises a central body (90) which fits in the longitudinal slot (20) and two side wings (91, 92) which abut against the edges (25, 26) of the outer roller (2).

This description continues with reference to the operation of the double roll type closure (100).

With reference to FIG. 3, initially, the black-out blind (O) is rolled completely on the inner roller (1) and the bottom rail (9) of the black-out blind is engaged in the longitudinal slot (20) of the outer roller. The curtain (T) is rolled completely on the outer roller (2) and therefore the windings of the curtain (T) press down the lever (7) in its retracted position against the action of the spring (M). In such a case, the hook (70) of the lever is not visible in FIG. 3.

Furthermore the windings of the curtain (T) also press down the bottom rail (9) in the longitudinal slot (20) of the outer roller, making the inner and the outer rollers integral while rotate. The motor (6) is locked and therefore the inner roller (1) cannot rotate.

As soon as the motor (6) is unlocked (i.e. the motor (6) is in neutral), if a weight is hung at the free end of the curtain (T), the curtain (T) goes down in the direction of the arrow (Y1) by gravity, causing the unrolling of the curtain (T) and the joined rotation of the outer roller (2) and the inner roller (1) in the direction of the arrow (F1). Alternatively, a rotation of the inner roller (1) in the direction of the arrow (F1) caused by the motor (6) would in any case cause a rotation of the outer roller (2) and the unrolling of the curtain (T).

When the curtain (T) is not completely unrolled, a rotation of the motor (6) in anticlockwise direction (arrow F1) causes the unrolling of the curtain; on the contrary, a rotation of the motor in clockwise direction (opposite to the arrow F1) causes the rolling of the curtain. The position of the curtain (T) can be adjusted in this way.

With reference to FIG. 4, when the curtain (T) is completely unrolled, the lever (7) of the outer roller is no longer pressed down by the windings of the curtain (T) and therefore the lever (7) snaps in its extracted position because of the action of the spring (M). In such a situation, the black-out blind (O) is still rolled and the bottom rail (9) is still in the longitudinal slot (20). Therefore a further rotation of the inner roller (1) in the direction of the arrow (F2) also causes a rotation of the outer roller (2) and therefore an approach of the hook (70) of the lever towards the stop member (8) secured with the second flange (4). In such a case the inner roller (1) and the outer roller (2) rotate together and therefore the black-out blind (O) is not unrolled from the inner roller (1).

With reference to FIG. 5, when the hook (70) of the lever abuts against the stop member (8), the outer roller (2) is locked and the inner roller (1) keeps on rotating in the direction of the arrow (F3). It must be noted how the provision of the lever (7) with the hook (70) and of the stop member (8) ensures the locking of the outer roller and a perfect unrolling of the black-out blind (O), without the need to use complex, unstable and uncertain counterweight systems.

With reference to FIG. 6, a further rotation of the inner roller (1) in the direction of the arrow (F4) causes the unrolling of the black-out blind (O), and consequently the disengagement of the bottom rail (9) from the longitudinal slot (20) and the lowering of the black-out blind in the direction of the arrow (Y2).

At this stage, the bottom rail (9) is out of the longitudinal slot (20) and therefore the inner roller (1) and the outer roller (2) are freed in mutual rotation.

When the black-out blind (O) is not completely rolled, an anticlockwise rotation of the motor (arrow F4) causes the unrolling of the black-out blind; on the contrary a clockwise rotation of the motor (opposite to arrow F4) causes the rolling of the black-out blind. The position of the black-out (O) can be adjusted in this way.

In order to roll or adjust the position of the curtain (T), the black-out blind must be rolled completely in such manner that the bottom rail (90) is engaged in the longitudinal slot (20) making the inner roller (1) integral with the outer roller (2) in rotation. In such a case a clockwise rotation of the inner roller causes a rotation of the outer roller and consequently the departure of the hook (70) from the stop member (8) and the winding of the curtain (T) on the outer roller (2), bringing the hook (70) to its retracted position.

Variations and equivalent modifications can be made to the present embodiment of the invention by a person skilled in the art, while still falling within the scope of the invention.

Although the figures show actuating mechanisms (6) comprising a tubular geared motor, the actuating mechanisms (6) may comprise a chain or a crank handle connected to the inner roller (1).

Although the drawings show a curtain (T) that is rolled or unrolled on the outer roller (2), the curtain (T) can be a Roman blind that closes like a folding curtain by means of traction exerted on the curtain by cords. In such a case, the cords of the Roman blind are rolled and unrolled on the outer roller tube (2) exactly in the same way in which the curtain (T) is rolled and unrolled.

1. Roll type closure comprising:
a fixed mounting frame,
an inner roller rotatably mounted to the fixed mounting frame,
an inner curtain secured to the inner roller,
a tubular hollow outer roller rotatably mounted on the inner roller in such manner that the inner roller and the outer roller are coaxial and rotate independently, the said outer roller being provided with a longitudinal slot for the passage of the inner curtain,
an outer curtain secured to the external roller,
actuating mechanisms connected to the inner roller in order to drive the inner roller into rotation,
a bottom rail disposed at the free end of the inner curtain and adapted to be coupled with the said longitudinal slot of the outer roller, when the inner curtain is rolled completely on the inner roller in such a manner to make the said inner and outer rollers integral in rotation,
a lever with a hook mounted on the said outer roller to move from a retracted position, in which the hook does not protrude from the outer roller, to an extracted position, in which the hook protrudes from the outer roller, the said lever being in said extracted position when the said outer curtain is unrolled completely, and
a stop member mounted in the said frame in such manner that when the lever is in extracted position the hook is stopped against the said stop member, blocking the rotation of the outer roller.

2. The roll type closure of claim 1, also comprising a spring that leads the said lever to the said extracted position.

3. The roll type closure of claim 2, wherein said lever has a curved shape and is hinged on the said external roller by means of a pin.

4. The roll type closure of claim 3, wherein the said spring is disposed between the said lever and a peg fitted to the said outer roller.

5. The roll type closure of claim 1, also comprising at least one collar, fitted to at least one end of the said outer roller and at least one bearing , disposed between the said inner roller and the said collar.

6. The roll type closure of claim 5, wherein the said lever is fixed to the said collar.

7. The roll type closure of claim 1, wherein the said fixed mounting frame comprises at least one flange disposed in at least one end of the inner roller and outer roller assembly and the said stop member is mounted on the said flange of the fixed mounting frame.

8. The roll type closure of claim 1, wherein the said actuating mechanisms comprise an electrically-operated geared motor.

9. The roll type closure of claim 8, wherein the said internal roller has a tubular hollow shape and the said actuating mechanisms comprise a tubular electrically-operated geared motor adapted to be inserted into the said inner roller.

10. The roll type closure of claim 9, also comprising a first adaptor and a second adaptor disposed between the electrically-operated geared motor and the inner roller, wherein the first adaptor is disposed on the drive shaft of the electrically-operated geared motor and the second adaptor is disposed on a stop ring of the electrically-operated geared motor.
